(19) United States
(12) Patent Application Publication
(10) Pub. No.: US 2026/0277450 A1
(43) Pub. Date: Sep. 17, 2026

(54) MEMORY SYSTEM

(71) Applicant: Kioxia Corporation, Tokyo (JP)

(72) Inventors: Tetsuya SUGIYAMA, Yokohama (JP); Masayuki SHIBAOKA, Yokohama (JP)

(73) Assignee: Kioxia Corporation, Tokyo (JP)

(21) Appl. No.: 19/317,531

(22) Filed: Sep. 3, 2025

(30) Foreign Application Priority Data
Mar. 11, 2025 (JP) 2025-038211

(51) Int. Cl. G06F 3/06

(52) U.S. Cl. CPC G06F 3/0619; G06F 3/0659; G06F 3/0673

(57) ABSTRACT

A memory controller stores first write data in a first memory in response to a first write command from a host. The memory controller transmits a completion response to the first write command to the host in response to storing the first write data in the first memory, if a first size, which is a total size of all sizes of the write data set in a first state stored in the first memory and a size of the first write data, is less than a first threshold value. If the first size is greater than the first threshold value, the memory controller transmits a completion response to the host as the first size is less than the first threshold value.

### CROSS-REFERENCE TO RELATED APPLICATION

This application is based upon and claims the benefit of priority from Japanese Patent Application No. 2025-038211, filed Mar. 11, 2025, the entire contents of which are incorporated herein by reference.

### FIELD

Embodiments described herein relate generally to a memory system.

### BACKGROUND

A memory system is known, which includes a nonvolatile memory functioning as a storage and a volatile memory functioning as a buffer or the like.

The memory system may be configured to execute a power loss protection (PLP) operation. The PLP operation is an operation in which various data, which includes data in the buffer and which is not yet written into the nonvolatile memory, is saved to the nonvolatile memory so as to cope with unexpected shutdown (power loss). The PLP operation is executed using electrical energy stored in a power storage device provided in the memory system.

### DESCRIPTION OF THE DRAWINGS

FIG. 1 is a schematic diagram illustrating an example of a configuration of a memory system according to an embodiment.

FIG. 2 is a diagram illustrating a configuration of a memory chip according to the embodiment.

FIG. 3 is a diagram illustrating an example of a configuration of a dynamic random access memory according to the embodiment.

FIG. 4 is a schematic diagram illustrating an example of a functional configuration of a memory controller according to the embodiment.

FIG. 5 is a flow chart showing an example of an operation executed in the memory system according to the embodiment when receiving a write command.

FIG. 6 is a flow chart showing an example of an operation executed in the memory system according to the embodiment when one write data is non-volatilized.

FIG. 7 is a flow chart showing an example of a PLP operation executed in the memory system according to the embodiment.

FIG. 8 is a schematic diagram illustrating an example of timing of an operation responding to a write command according to the embodiment.

FIG. 9 is a diagram illustrating an example of a state of write data in the write buffer responding to the write command according to the embodiment.

FIG. 10 is a schematic diagram illustrating an example of timing of an operation responding to a write command according to a modification example of the embodiment.

FIG. 11 is a diagram illustrating an example of a state of write data in the write buffer responding to the write command according to the modification example of the embodiment.

### DETAILED DESCRIPTION

Embodiments provide a memory system having a write buffer with a larger size for the amount of electrical energy the power storage device is able to store.

In general, according to one embodiment, a memory system is connectable to a host. The memory system includes a first memory that is volatile, a second memory that is nonvolatile, and a memory controller. The memory controller is configured to execute a first write operation, the first write operation including (i) acquiring, from the host, write data requested based on a write command from the host; (ii) storing the acquired write data in the first memory; (iii) reading the stored write data from the first memory; and (iv) writing the read write data into the second memory. The memory controller is further configured to manage a state of each of a plurality of pieces of write data stored in the first memory, as a first state or a second state different from the first state. The memory controller is further configured to, in the first write operation for first write data requested based on a first write command from the host, store the first write data in the first memory; and in response to the storing of the first write data in the first memory, if a first size, which is a total size of all sizes of one or more of the plurality of pieces of write data set in the first state stored in the first memory and a size of the first write data, is less than a first threshold value, transmit, to the host, a completion response to the first write command and set the state of the first write data to the first state, if the first size is greater than the first threshold value, set the state of the first write data to the second state without transmitting, to the host, the completion response. The memory controller is further configured to, as the first size becomes less than the first threshold value in response to writing, to the second memory, any one of the one or more of the plurality of pieces of write data set in the first state stored in the first memory, transmit, to the host, the completion response to the first write command, and change the state of the first write data from the second state to the first state.

A memory system according to an embodiment will be described in detail below with reference to the accompanying drawings. It is noted that the embodiment does not limit the present disclosure.

### Embodiment

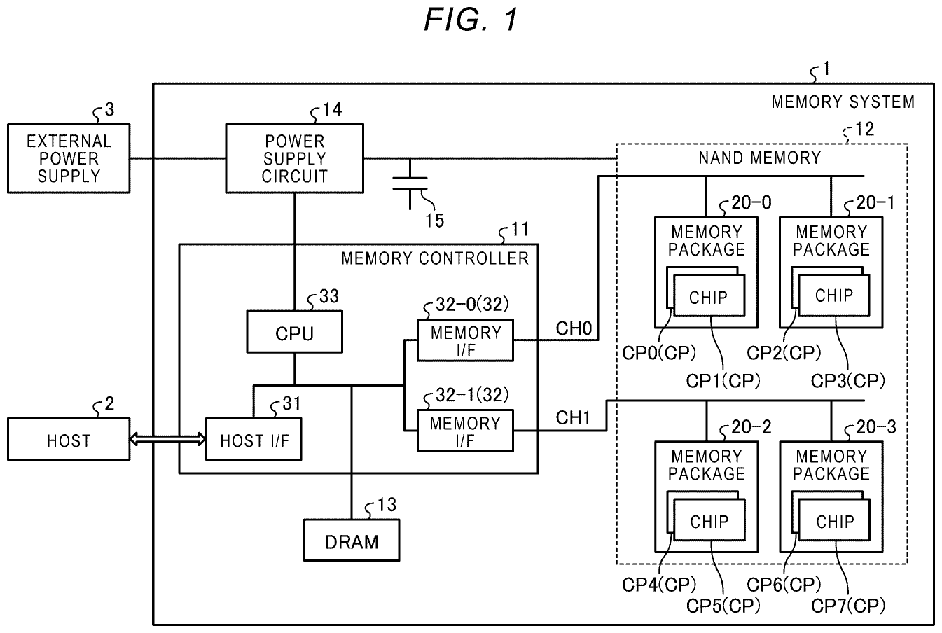

FIG. 1 is a schematic diagram illustrating an example of a configuration of a memory system according to an embodiment. As illustrated in FIG. 1, a memory system 1 is connectable to a host 2 via a predetermined communication interface. The host 2 may be, for example, a processor, a personal computer, a portable information terminal, or a server. The memory system 1 is able to accept various commands from the host 2. The various commands include write or read commands, or the like. When the memory system 1 is connected to an external power supply 3, the memory system 1 receives power from the external power supply 3. The external power supply 3 may be built in the host 2.

The memory system 1 includes a memory controller 11, a NAND flash memory (NAND memory) 12, a dynamic random access memory (DRAM) 13, a power supply circuit (power management circuit) 14, and a power storage device 15.

The memory controller 11 is configured with a circuit such as a system-on-a-chip (SoC). The function of each section of the memory controller 11 may be implemented by a dedicated hardware circuit, a processor that executes a program (firmware), or a combination thereof.

The NAND memory 12 is a nonvolatile memory that functions as a storage. The NAND memory 12 includes at least one memory chip CP. Here, eight memory chips CP0 to CP7 are illustrated as examples of at least one memory chip CP. The plurality of memory chips CP may be configured as a single package sealed with resin or the like. Here, for example, a memory package 20-0 including the memory chips CP0 and CP1, a memory package 20-1 including the memory chips CP2 and CP3, a memory package 20-2 including the memory chips CP4 and CP5, and a memory package 20-3 including the memory chips CP6 and CP7 are illustrated.

The memory controller 11 and the NAND memory 12 are connected via at least one channel. Here, for example, the memory system 1 includes two channels CH0 and CH1. The two channels CH0 and CH1 are connected to the memory controller 11. The channel CH0 is connected to the memory packages 20-0 and 20-1, and the channel CH1 is connected to the memory packages 20-2 and 20-3.

It is noted that this example does not limit, in the memory system 1, the number of channels, the number of memory chips CP, the number of memory packages 20, and the wiring between the memory controller 11 and each memory chip CP.

The memory controller 11 executes various kinds of processing including data transfer between the host 2 and the NAND memory 12. As a configuration for this purpose, the memory controller 11 includes a host interface (I/F) circuit 31, at least one memory I/F circuit 32, and a central processing unit (CPU) 33.

The host I/F circuit 31 controls transfer of information such as requests and data to and from the host 2.

The CPU 33 implements control of the entire memory controller 11 on the basis of a firmware program.

The memory I/F circuit 32 transfers a command to the memory chip CP via the channel, and transfers data corresponding to the command to and from the NAND memory 12, on the basis of an instruction issued from the CPU 33. The command transferred via the channel includes commands to write data, read data, and erase data.

In the example illustrated in FIG. 1, the memory controller 11 includes two memory I/F circuits 32-0 and 32-1 as examples of at least one memory I/F circuit 32. The memory I/F circuit 32-0 controls the transfer of commands and data via the channel CH0, and the memory I/F circuit 32-1 controls the transfer of commands and data via the channel CH1. The number of memory I/F circuits 32 provided in the memory controller 11 is not limited to two.

The DRAM 13 is a volatile memory that functions as a buffer or cache. For example, the memory controller 11 may use the DRAM 13 as a buffer for data transferred between the host 2 and the NAND memory 12, or as a region for temporarily storing various management information such as logical-to-physical address conversion information. The logical-to-physical address conversion information is information that stores correspondence between a logical address and a physical address. The logical address is used by the host 2 to specify a location of data. The physical address indicates a location in the NAND memory 12 where the data is stored.

It is noted that the memory system 1 may have a plurality of volatile memories that function as buffers or caches. The type of volatile memory that functions as a buffer or cache is not limited to the DRAM. For example, the memory system 1 may include a static random access memory (SRAM) in addition to the DRAM 13 as a volatile memory that functions as a buffer or cache.

The power supply circuit 14 generates power for driving the memory controller 11, the NAND memory 12, the DRAM 13, and the power storage device 15 on the basis of the power which is input from the external power supply 3. Then, the power supply circuit 14 supplies the generated power to the memory controller 11, the NAND memory 12, the DRAM 13, and the power storage device 15.

The power storage device 15 is able to store electrical energy. The power storage device 15 may be, for example, a rechargeable capacitor or battery. In the following, the power storage device 15 is referred to as a capacitor 15. When the external power supply 3 supplies power, the power supply circuit 14 charges the capacitor 15, and the capacitor 15 stores electrical energy. When the power supply is shut down, that is, when the external power supply 3 stops supplying power (that is, cuts off power), the power supply circuit 14 switches the power supply source from the external power supply 3 to the capacitor 15. Thereby, power is supplied to the memory controller 11, the NAND memory 12, and the DRAM 13 via the power supply circuit 14 on the basis of the electrical energy stored in the capacitor 15. The memory controller 11, the NAND memory 12, and the DRAM 13 are able to operate with the electrical energy stored in the capacitor 15 for a while even after the power supply from the external power supply 3 is stopped. The memory controller 11 executes a PLP operation by using the electrical energy stored in the capacitor 15. Through the PLP operation, data, which is stored in the volatile memory (e.g., DRAM 13) and which is not yet stored in the nonvolatile memory (e.g., the NAND memory 12), is saved into the nonvolatile memory.

In one example, the power supply circuit 14 monitors a voltage which is supplied from the external power supply 3. If the voltage is lower than a predetermined level, the power supply circuit 14 determines that the power supply is shut down and transmits a shutdown signal to the CPU 33 in the memory controller 11. Then, the power supply circuit 14 switches the power supply source from the external power supply 3 to the capacitor 15. The CPU 33 starts the PLP operation in response to the shutdown signal transmitted from the power supply circuit 14.

It is noted that the element for detecting the shutdown does not have to be the power supply circuit 14. For example, the CPU 33 may detect the shutdown.

Any type of capacitor can be used as the capacitor 15. For example, an electrolytic capacitor or an electric double layer capacitor may be employed as the capacitor 15.

Examples of a situation in which the power supply from the external power supply 3 is stopped may include a situation in which the power supply is stopped after the memory system 1 receives a notice from the host 2, and a situation in which the power supply is stopped without the notice. When receiving the notice, the memory controller 11 may be configured to shut down the memory system 1 including the same processing as the PLP operation, which is executed in response to the notice. When the power supply is stopped without the notice, the memory controller 11 may be configured to start the PLP operation in response to the shutdown signal. In the present application, the shutdown includes at least the situation in which the power supply is stopped without the notice.

It is noted that the DRAM 13 is an example of a first memory that is volatile. The NAND memory 12 is an example of a second memory that is nonvolatile.

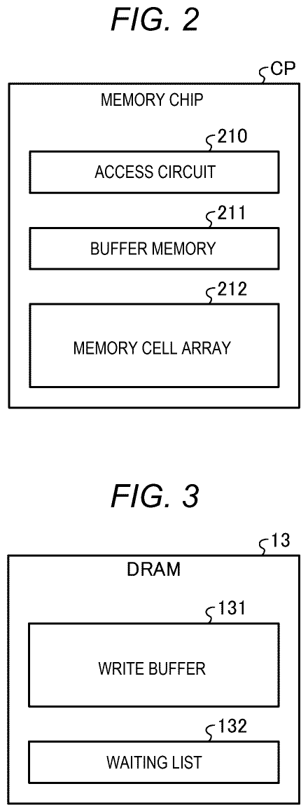

FIG. 2 is a diagram illustrating a configuration of the memory chip CP according to the embodiment. The memory chip CP includes an access circuit 210, a buffer memory 211, and a memory cell array 212.

The memory cell array 212 is configured such that a plurality of memory cell transistors are two-dimensionally or three-dimensionally arranged. Each memory cell transistor is configured to non-volatilely store data of one or more bits.

Write and read operations are executed on the memory cell array 212 in units of a storage region referred to as a page. The write operation for the memory cell array 212 is also referred to as a program operation. The read operation from the memory cell array 212 is also referred to as a sense operation.

An erase operation is executed on data stored in the memory cell array 212 in units of a storage region referred to as a block, which is a storage region larger than a page.

The access circuit 210 includes a row decoder, a column decoder, a sense amplifier, and a voltage generation circuit. When receiving a command from the memory controller 11, the access circuit 210 executes an operation in accordance with the received command.

The access circuit 210 is able to execute a data-in operation, a program operation, a sense operation, a data-out operation, an erase operation, or the like, in response to the received command. The data-in operation is an operation for transferring data from the memory controller 11 to the memory chip CP. The buffer memory 211 stores the data transferred by the data-in operation. The program operation is an operation in which data transferred by the data-in operation and stored in the buffer memory 211 is programmed into the memory cell array 212. The sense operation is an operation in which data stored in the memory cell array 212 is sensed and the buffer memory 211 stores the data obtained by the sensing. The data-out operation is an operation in which the data stored in the buffer memory 211 is output to the memory controller 11. The erase operation is an operation for erasing data stored in the memory cell array 212.

In the write operation to the NAND memory 12, the memory I/F circuit 32 causes the access circuit 210 to store data in the buffer memory 211 through the data-in operation. Thereafter, the memory I/F circuit 32 causes the access circuit 210 to program the data into the memory cell array 212 through the program operation.

In the read operation from the NAND memory 12, the memory I/F circuit 32 causes the access circuit 210 to transfer data stored in the memory cell array 212 to the buffer memory 211 through the sense operation. Thereafter, the memory I/F circuit 32 causes the access circuit 210 to output the data stored in the buffer memory 211 to the memory controller 11 through the data-out operation. It is noted that the sense operation may be omitted if the data to be read is already stored in the buffer memory 211.

FIG. 3 is a diagram illustrating an example of a configuration of the DRAM 13 according to the embodiment.

In the DRAM 13, a write buffer 131 is allocated. The write buffer 131 temporarily stores data (hereinafter, write data) that is requested to be written by a write command from the host 2. The write buffer 131 is configured to store a plurality of pieces of write data each of which is requested to be written by a different write command. The write data stored in the write buffer 131 is then written into the NAND memory 12.

Techniques compared to the embodiment will be described. The techniques compared to the embodiment is referred to as a comparative example.

In the comparative example, in order to minimize a latency to a write command, a memory controller transmits a response (hereinafter, a completion response) to a host indicating that execution of the write command is completed when write data is stored in a write buffer.

According to various standards, if a memory system transmits a completion response to the host, it is necessary to ensure that the write data requested to be written by the completed write command is written into a nonvolatile memory (e.g., the NAND memory). In contrast, according to various standards, if the memory system does not transmit a completion response to the write command, it is not necessary to ensure that the write data requested to be written by the write command is written into the nonvolatile memory. According to the comparative example, all of the write data, which are not yet stored in its nonvolatile memory, among the write data stored in the write buffer are determined to be saved through a PLP operation. Therefore, a capacitance of a capacitor provided in the memory system is determined such that the write data having an amount of equal to the size of the write buffer can be maximally saved.

In recent years, it may be necessary to increase the size of the write buffer for a variety of reasons.

For example, an increase in size of the write buffer contributes to improvement in write performance from the viewpoint of the host. Therefore, it may be required to increase the size of the write buffer in order to improve the write performance.

In another example, a larger size of the write buffer may be required to implement a design with a larger superpage size. For example, a memory system is configured such that a plurality of channels can be controlled in parallel, a plurality of memory chips connected to one channel can be controlled in parallel, or one memory cell array can be divided into a plurality of sub-arrays to access a plurality of sub-arrays in parallel. In a case where such a configuration is applied, the superpage is configured with a group of pages selected from each parallel operation element. The memory controller performs a write operation on the group of the pages constituting the superpage. Therefore, it is necessary for the write buffer to have a size capable of storing the write data having an amount of at least one superpage size. The more parallel operation elements, the better the performance of the memory system. Meanwhile, the size of the superpage increases, and the required size of the write buffer increases as the size of the superpage increases.

In yet another example, in a memory system with multi-stream functionality, it may be necessary to increase the size of the write buffer in order to implement a design with a large number of streams. In order to perform a write operation with maximum efficiency, it is necessary to perform write operations on a large number of or all memory chips simultaneously. For example, if a write target superpage differs for each stream, the write operation target for each of the plurality of streams can be the same memory chip. In such a case, some or all of the write operations for a superpage have to wait until executed. Even if the write buffer has a size of a plurality of superpages, the write buffer is wasted due to the waiting. In contrast, if the write buffer has only a size of one superpage, some memory chips will be no longer the write operation targets. That is, the larger the number of streams, the larger the required size of the write buffer required for maximum efficiency to perform the write operations. For example, ideally the write buffer has a size capable of storing write data in the amount of one superpage size per stream, for all streams that are open. Thereby, it is possible to perform the write operations on all memory chips at any time.

According to the comparative example, the larger the size of the write buffer, the larger the amount of write data to be saved through the PLP operation. Therefore, in a case where a design with a large size of the write buffer is implemented, it is necessary to increase the capacitance of the capacitor provided in the memory system. As the capacitance of the capacitor provided in the memory system increases, the cost of the memory system increases, and the mounting area for the capacitor increases.

According to the embodiment, the amount of write data less than the size of the write buffer 131 is set as the maximum amount of write data to be saved through the PLP operation. The maximum amount of write data to be saved through the PLP operation is referred to as an ensured threshold value. The ensured threshold value is, for example, a fixed value determined in design. The ensured threshold value corresponds, for example, to the maximum amount of write data that is writable into the NAND memory 12 by using the maximum electrical energy that can be stored in the capacitor 15.

The ensured threshold value is stored, for example, in the NAND memory 12 or in a read-only memory (ROM), which is not illustrated. The memory controller 11, for example, loads the ensured threshold value into the DRAM 13 when the memory system 1 is activated, and manages the ensured threshold value.

For example, when new write data is stored in the write buffer 131 in response to a new write command, the total size of the new write data and all of the write data, which are not yet written into the NAND memory 12 among write data already stored in the write buffer 131, may be less than the ensured threshold value. In such a case, the memory controller 11 transmits a completion response, which indicates that execution of the new write command is completed, to the host 2, in response to the storing of the new write data in the write buffer 131.

In contrast, the total size of the new write data and all of the write data, which are not yet written into the NAND memory 12 among write data already stored in the write buffer 131 may become greater than the ensured threshold value. In such a case, the memory controller 11 does not transmit the completion in response to the storing of the new write data in the write buffer 131. Then, when the amount of write data, which is not yet written into the NAND memory 12 among the write data stored in the write buffer 131 changes and a predetermined condition is satisfied, the memory controller 11 transmits the completion response, which indicates that the execution of the new write command is completed, to the host 2.

In such a manner, the memory controller 11 adjusts the timing of transmitting the completion response to each write command. Thereby, the total size of write data to be saved through the PLP operation is reduced to the ensured threshold value or less. With such a configuration, a design, in which the size of the write buffer 131 is increased, is possible even when the capacitance of the capacitor 15 provided in the memory system 1 is not increased. Alternatively, a design, in which the capacitance of the capacitor 15 provided in the memory system 1 is reduced, is possible without change in size of the write buffer 131.

Hereafter, writing the write data, which is stored in the write buffer 131, into the NAND memory 12 is referred to as non-volatilizing the write data. Further, for simplification of description, the write data stored in the write buffer 131 means write data which is not yet non-volatilized among write data stored in the write buffer 131.

The memory controller 11 manages a state of the write data stored in the write buffer 131. The state of the write data stored in the write buffer 131 includes a state in which the write data is subject to being saved through the PLP operation and a state in which the write data is not subject to being saved through the PLP operation. The state in which the write data is subject to being saved through the PLP operation is referred to as a PLP ensured state. The state in which the write data is not subject to being saved through PLP operation is referred to as a PLP non-ensured state. The write data in the PLP ensured state may be referred to as PLP ensured data. The write data in the PLP non-ensured state may be referred to as PLP non-ensured data.

The memory controller 11 manages a write command and write data requested to be written by the write command in association with each other. In the following, the write data requested to be written by a certain write command is referred to as write data corresponding to the write command. Further, the write command requesting writing of certain write data is referred to as a write command corresponding to the write data.

The DRAM 13 stores a waiting list 132. The waiting list 132 is a list of information about write commands of which the corresponding write data is already stored in the write buffer 131 and a completion response is not transmitted. In other words, the waiting list 132 can be considered as a list of information about write commands corresponding to the write data that is in the PLP non-ensured state.

The waiting list 132 may be configured, for example, as a list including pairs of command identification information for a write command and the size of write data corresponding to the write command. It is noted that a specific configuration of the waiting list 132 is not limited to this example.

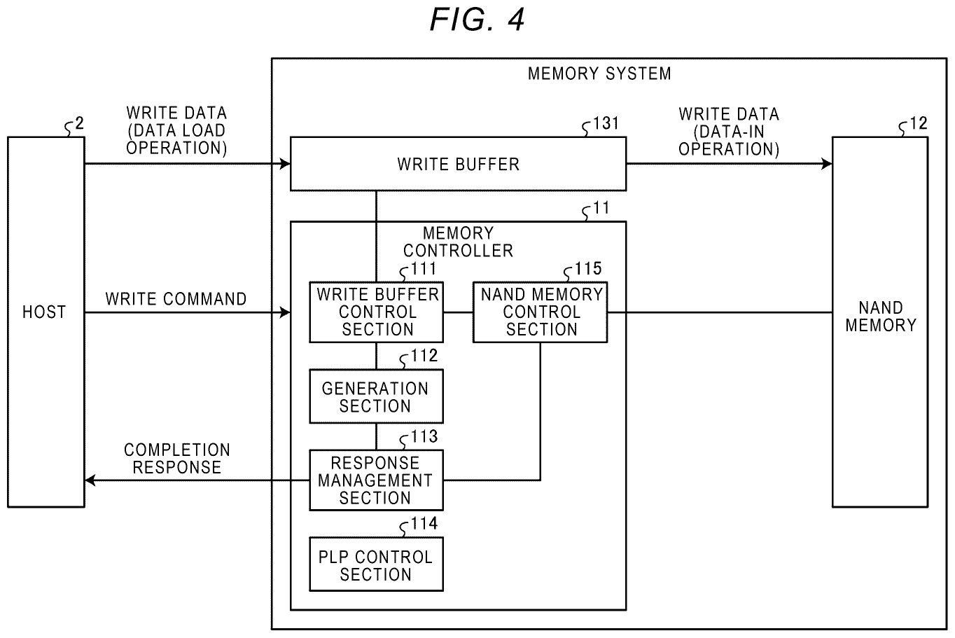

FIG. 4 is a schematic diagram illustrating an example of a functional configuration of the memory controller 11 according to the embodiment.

The memory controller 11 functions as a write buffer control section 111, a generation section 112, a response management section 113, a PLP control section 114, and a NAND memory control section 115, through the cooperation of some or all of the host I/F circuit 31, two memory I/F circuits 32, and the CPU 33.

When the memory controller 11 receives a write command, the write buffer control section 111 receives write data corresponding to the write command from the host 2 and stores the received write data in the write buffer 131. An operation of receiving the write data from the host 2 and storing the received write data in the write buffer 131 is referred to as a data load operation. When the write buffer 131 stores the write data, that is, when the data load operation is completed, the write buffer control section 111 notifies the generation section 112 that the storing of the write data in the write buffer 131 is completed.

In response to a notification of non-volatilization completion from the NAND memory control section 115 to be described later, the write buffer control section 111 releases a region in the write buffer 131 in which the write data for which the non-volatilization is completed is stored. It is noted that releasing a region means making the region available for storage of new data (that is, new write data). The write data, which is stored before the region is released, is unavailable after the release. Thus, management of the state of write data stored in that region, that is, management as to whether the write data is in the PLP ensured state or the PLP non-ensured state, is terminated, by releasing the region.

In response to the notification from the write buffer control section 111 that the data load operation is completed, the generation section 112 generates a candidate of a completion response to a write command. The generation section 112 transfers the generated candidate of the completion response to the response management section 113.

The candidate of the completion response includes, for example, command identification information about the write command and the size of the write data corresponding to the write command. It is noted that a specific configuration of the candidate of the completion response is not limited to this example.

The NAND memory control section 115 controls the writing of the write data, which is stored in the write buffer 131, into the NAND memory 12. That is, the NAND memory control section 115 instructs the NAND memory 12 to perform a data-in operation and a program operation on the write data. When the program operation for the write data is completed, the NAND memory control section 115 transmits the notification of non-volatilization completion to the write buffer control section 111 and the response management section 113. Consequently, in the embodiment, non-volatilization is considered to be completed upon completion of the program operation.

The notification of non-volatilization completion includes, for example, command identification information about the write command corresponding to the write data for which non-volatilization is completed, and the size of the write data. It is noted that a specific configuration of the notification of non-volatilization completion is not limited to this example.

The response management section 113 controls the timing of transmitting a completion response to the host 2 on the basis of the candidate of the completion response and the notification of non-volatilization completion. The response management section 113 manages the waiting list 132 and monitors the amount of PLP ensured data in order to control the timing of transmitting the completion response. The amount of PLP ensured data is the total size of all the PLP ensured data, that is, the total size of all the write data in the PLP ensured state stored in the write buffer 131. Further details of the functions of the response management section 113 will be clarified in the description of operation.

When the shutdown is detected, the PLP control section 114 executes the PLP operation. In the PLP operation, the PLP control section 114 saves the PLP ensured data to the NAND memory 12 and does not save the PLP non-ensured data to the NAND memory 12.

Next, details of the operation of the memory system 1 according to the embodiment will be described.

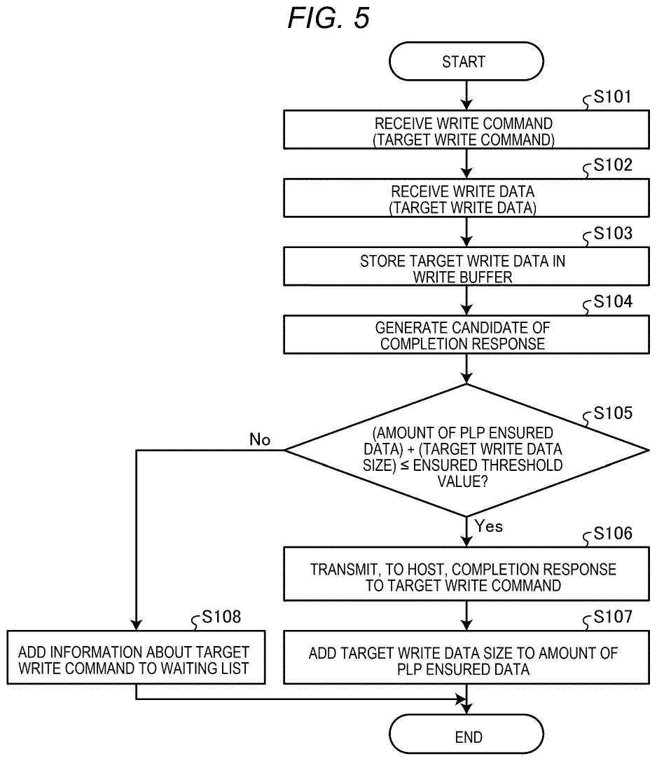

FIG. 5 is a flow chart showing an example of the operation executed in the memory system 1 according to the embodiment when receiving a write command.

The memory controller 11 receives the write command from the host 2 (S101). In response to the receiving of the write command, the write buffer control section 111 receives write data corresponding to the write command from the host 2 (S102), and stores the write data in the write buffer 131 (S103).

The write command received from the host 2 in Step S101 is referred to as a target write command in the illustration of FIG. 5. In addition, the write data corresponding to the target write command is referred to as target write data in the illustration of FIG. 5.

The generation section 112 generates the candidate of the completion response including information about the target write command in response to the storing of the target write data in the write buffer 131 (S104).

The response management section 113 determines whether a total size of the amount of PLP ensured data and the size of the target write data is equal to or less than the ensured threshold value, on the basis of the candidate of the completion response (S105). That is, in Step S105, the response management section 113 determines whether the total size of all the PLP ensured data and the target write data is equal to or less than the ensured threshold value.

If the total size of the amount of PLP ensured data and the size of the target write data is equal to or less than the ensured threshold value (S105: Yes), it is possible to save not only the current PLP ensured data but also the target write data in the PLP operation. Therefore, the response management section 113 transmits, to the host 2, the completion response to the target write command (S106).

The response management section 113 updates the amount of PLP ensured data with the value obtained by adding the size of the target write data to the current value of the amount of PLP ensured data (S107). Then, the operation upon the receiving of the target write command is completed.

If the control is performed through Steps S106 and S107, the information about the target write command is not listed on the waiting list 132. In other words, it can be considered that the state of the target write data is set to the PLP ensured state.

If the total size of the amount of PLP ensured data and the size of the target write data is not equal to or less than the ensured threshold value (S105: No), it is difficult to save the target write data in addition to all the current PLP ensured data in the PLP operation. Therefore, the response management section 113 adds the information about the target write command, which is recorded in the candidate of the completion response, to the waiting list 132 (S108). Then, the operation upon the receiving of the target write command is completed.

The adding of the information about the target write command to the waiting list 132 through the processing in Step S108 means that the target write data is PLP non-ensured data. In other words, it can be considered that the state of the target write data is set to the PLP non-ensured state.

In the example illustrated in FIG. 5, if the total size of the amount of PLP ensured data and the size of the target write data is equal to the ensured threshold value, the control proceeds to Step S106. This example does not limit the operation performed when the total size of the amount of PLP ensured data and the size of the target write data is equal to the ensured threshold value. For example, the control may proceed to Step S108.

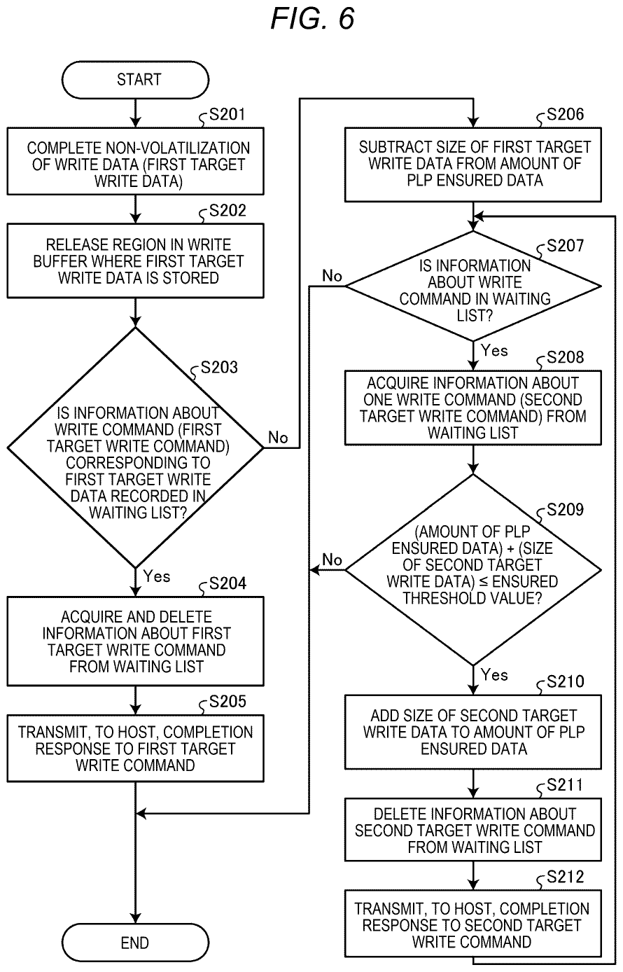

FIG. 6 is a flow chart showing an example of an operation executed in the memory system 1 according to the embodiment when one write data is non-volatilized.

If the NAND memory control section 115 completes non-volatilization of one write data (S201), the NAND memory control section 115 transmits information about the non-volatilized write data to the write buffer control section 111 and the response management section 113 as a notification of non-volatilization completion.

The write data, for which the non-volatilization is completed in the processing of Step S201, is referred to as first target write data in the illustration of FIG. 6. In addition, a write command corresponding to the first target write data is referred to as a first target write command.

The write buffer control section 111 releases a region in the write buffer 131 in which the first target write data is stored, on the basis of the notification of the non-volatilization completion (S202).

The response management section 113 determines whether the information about the first target write command is recorded on the waiting list 132 (S203). That is, in Step S203, the response management section 113 determines whether the first target write data is in the PLP non-ensured state.

If the information about the first target write command is recorded in the waiting list 132 (S203: Yes), the response management section 113 acquires the information about the first target write command from the waiting list 132 and deletes the information from the waiting list 132 (S204). Then, the response management section 113 transmits, to the host 2, the completion response to the first target write command, on the basis of the acquired information about the first target write command (S205).

If the information about the first target write command is not recorded in the waiting list 132 (S203: No), that is, if the first target write data is in the PLP ensured state, the response management section 113 updates the amount of PLP ensured data with a value obtained by subtracting the size of the first target write data from the current value of the amount of PLP ensured data (S206).

The response management section 113 determines whether information about a write command is in the waiting list 132 (S207). That is, the response management section 113 determines whether write data currently in the PLP non-ensured state is present.

If no information about a write command is in the waiting list 132 (S207: No), the operation performed when one write data is non-volatilized is completed.

If information about a write command is in the waiting list 132 (S207: Yes), the response management section 113 acquires the information about the write command from the waiting list 132 (S208).

The write command indicated by the information obtained from the waiting list 132 in the processing of Step S208 is referred to as a second target write command in the illustration of FIG. 6. The write data corresponding to the second target write command is referred to as second target write data in the illustration of FIG. 6. The second target write data is write data that is in the PLP non-ensured state.

If information about a plurality of write commands is in the waiting list 132, it may be optionally designed which write command information is acquired in Step S208. In one example, the response management section 113 may be configured to obtain information about the write command, which is received at the earliest timing from the host 2, in the information about the plurality of write commands recorded in the waiting list 132.

In another example, when a write command has attribute information such as priority information or stream information, the response management section 113 may be configured to select one of the information about the plurality of write commands recorded in the waiting list 132 on the basis of the attribute information.

The response management section 113 determines whether the total size of the amount of PLP ensured data and the size of the second target write data is less than or equal to the ensured threshold value (S209). That is, in Step S209, the response management section 113 determines whether the total size of all the PLP ensured data and the second target write data is equal to or less than the ensured threshold value.

If the total size of the amount of PLP ensured data and the size of the second target write data is equal to or less than the ensured threshold value (S209: Yes), it is possible to save not only the current PLP ensured data but also the second target write data during the PLP operation. Therefore, the response management section 113 updates the amount of PLP ensured data with the value obtained by adding the size of the second target write data to the current value of the amount of PLP ensured data (S210). The response management section 113 deletes the information about the second target write command from the waiting list 132 (S211). Then, the response management section 113 transmits, to the host 2, the completion response to the second target write command (S212). After Step S211, the control proceeds to Step S207.

When the control is performed through Steps S210 to S212, the second target write data is treated as write data in the PLP ensured state until it is non-volatilized. In other words, it can be considered that the state of the second target write data is changed from the PLP non-ensured state to the PLP ensured state.

In the example illustrated in FIG. 6, if the total size of the amount of PLP ensured data and the size of the second target write data is equal to the ensured threshold value, the control proceeds to Step S208. This example does not limit the operation performed when the total size of the amount of PLP ensured data and the size of the second target write data is equal to the ensured threshold value. For example, the operation performed when one write data is non-volatilized may be completed.

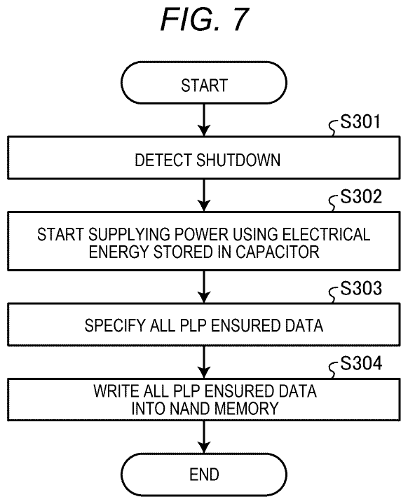

FIG. 7 is a flow chart showing an example of the PLP operation executed in the memory system 1 according to the embodiment.

If shutdown is detected (S301), the power supply circuit 14 starts supplying power using the electrical energy stored in the capacitor 15 (S302).

The PLP control section 114 specifies all the PLP ensured data in the write buffer 131 (S303).

A method of specifying the PLP ensured data in the write buffer 131 is freely selected. For example, the PLP control section 114 may determine whether each write data is PLP ensured data on the basis of a PLP ensured data list not illustrated. The PLP ensured data list includes, for example, information indicating the size of the PLP ensured data, a location in the write buffer 131 in which the PLP ensured data is stored, and command identification information for a write command corresponding to the PLP ensured data.

The PLP control section 114 writes all the specified PLP ensured data in the write buffer 131 into the NAND memory 12 (S304). Then, the PLP operation ends.

As described above, various types of management information can be stored in the DRAM 13, in addition to write data. In the PLP operation, the management information is also set to be saved, in addition to write data in the PLP ensured state. In the example illustrated in FIG. 7, the saving of such management information will not be described.

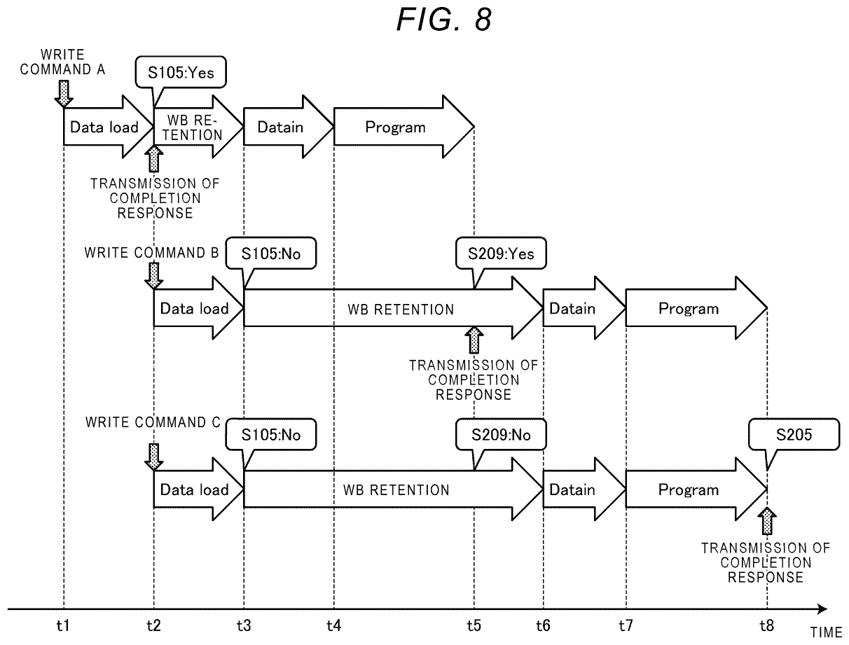

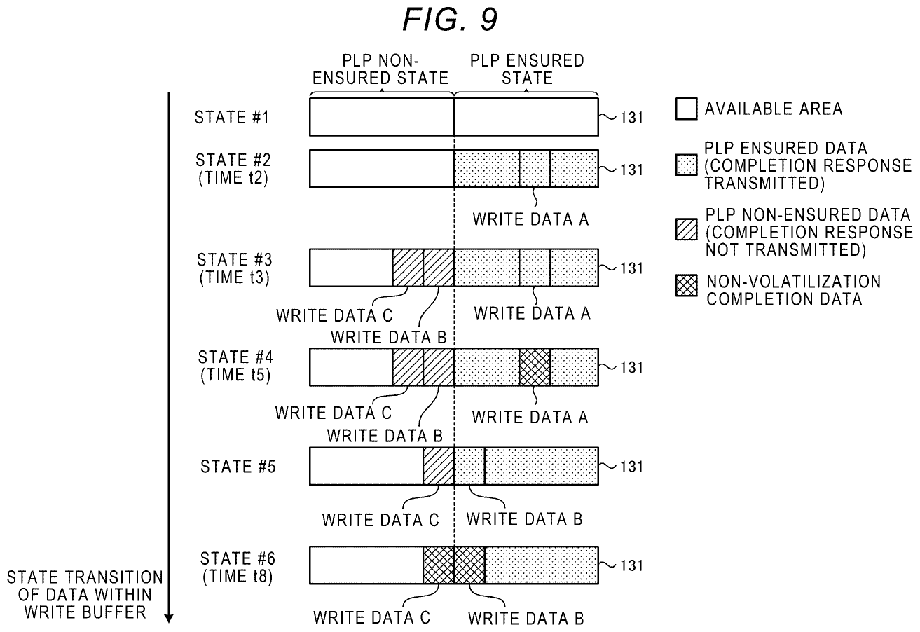

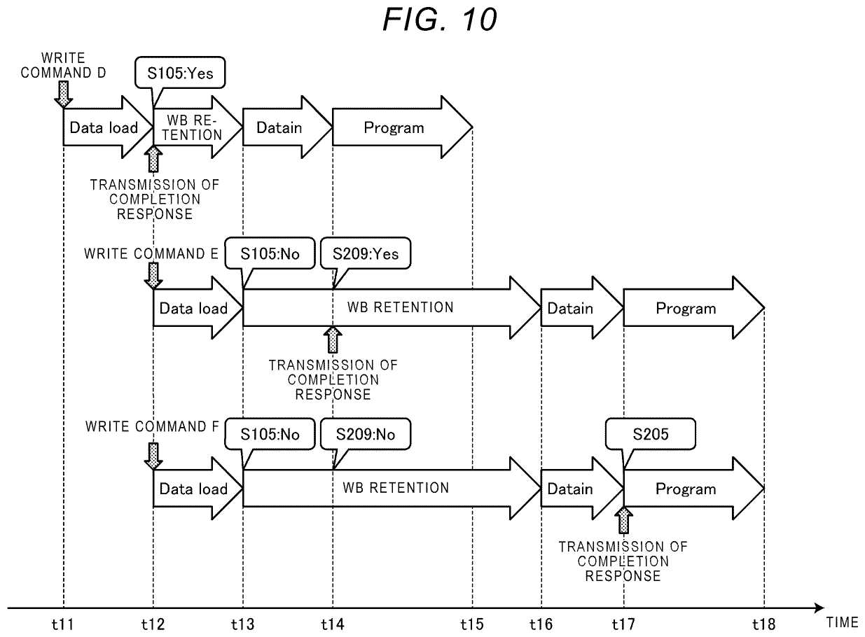

An example of the timing of transmitting the completion response to a write command will be described with reference to FIGS. 8 and 9.

FIG. 8 is a schematic diagram illustrating an example of timing of the operation responding to the write command according to the embodiment. In FIG. 8, the horizontal axis represents time.

In the example illustrated in FIG. 8, an operation responding to a write command A starts at time t1. From time t1, a data load operation for write data (represented as write data A) corresponding to the write command A is performed, and the data load operation is completed at time t2. In this case, it is assumed that the result of the determination in Step S105 illustrated in FIG. 5 is positive, and thus the completion response is transmitted in response to the completion of the data load operation. That is, the write data A is in the PLP ensured state.

The write data A stored in the write buffer 131 is retained in the write buffer 131 for a while and is transferred to the NAND memory 12 through a data-in operation at time t3. Then, a program operation of the write data A starts at time t4, and the program operation of the write data A is completed at time t5.

At time t2, an operation responding to a write command B starts. From time t2, a data load operation for write data (represented as write data B) corresponding to the write command B is performed, and the data load operation is completed at time t3. In this case, it is assumed that the result of the determination in Step S105 is negative, thereby preventing the transmission of the completion in response to the completion of the data load operation. That is, the write data B is in the PLP non-ensured state.

The write data B stored in the write buffer 131 is retained in the write buffer 131 for a while. When the program operation of the write data A is completed at time t5, the write command B is determined in Step S209 illustrated in FIG. 6. It is assumed that the determination in Step S209 is positive, and the completion response to the write command B is transmitted. From time t5, the write data B is in the PLP ensured state.

The write data B is transferred to the NAND memory 12 through a data-in operation at time t6. Then, a program operation of the write data B starts at time t7, and the program operation of the write data B is completed at time t8.

At time t2, an operation responding to a write command C starts in addition to the write command B. From time t2, a data load operation for write data (represented as write data C) corresponding to the write command C is performed, and the data load operation is completed at time t3. In this case, it is assumed that the result of the determination in Step S105 is negative, thereby preventing the transmission of the completion in response to the completion of the data load operation. That is, the write data C is in the PLP non-ensured state.

The write data C stored in the write buffer 131 is retained in the write buffer 131 for a while. When the program operation of the write data A is completed at time t5, the write command C is determined in Step S209 illustrated in FIG. 6. It is assumed that the determination in Step S209 is negative, thereby preventing the transmission of the completion to the write command C. From time t5, it is also considered that the write data C is maintained in the PLP non-ensured state.

The write data C is transferred to the NAND memory 12 through a data-in operation at time t6. Then, a program operation of the write data C starts at time t7, and the program operation of the write data C is completed at time t8. Then, in response to the completion of the program operation, the completion response to the write command C is transmitted to the host 2 on the basis of the processing in Step S205.

FIG. 9 is a diagram illustrating an example of the state of write data in the write buffer 131 at several timings illustrated in FIG. 8.

State #1 illustrated in FIG. 9 indicates a state in which no write data is stored in the write buffer 131. In FIG. 9, the write data in the write buffer 131 is drawn up on the right side in order to easily grasp the total amount of PLP ensured data.

Immediately after time t2, as shown in State #2, the amount of PLP ensured data including the write data A is equal to the ensured threshold value. Then, at time t3, as shown in State #3, the write data B and the write data C are stored in the write buffer 131. Since the total amount of write data in the write buffer 131 is greater than the ensured threshold value, the write data B and the write data C are in the PLP non-ensured state.

At time t5, as shown in State #4, the region in which the write data A is stored is released in response to the completion of the program operation of the write data A.

At time t5, as shown in State #5, the completion response to the write command B is transmitted. Thereby, the state of write data B is changed from the PLP non-ensured state to the PLP ensured state.

At time t8, as shown in State #6, the regions in which the write data B and the write data C are stored are released in response to the completions of the program operations for these write data.

### Modification Example

In the example described above, in response to the completion of a program operation of write data, a region in which the write data is stored in the write buffer 131 is released. The timing of releasing the region of the write buffer 131 is not limited thereto. As a modification example of the embodiment, a configuration in which the region of the write buffer 131 is released in response to the completion of a data-in operation will be described.

FIG. 10 is a schematic diagram illustrating an example of timing of an operation responding to a write command according to the modification example of the embodiment. In FIG. 10, the horizontal axis represents time.

In the example illustrated in FIG. 10, an operation responding to a write command D starts at time t11. From time t11, a data load operation for write data (represented as write data D) corresponding to the write command D is performed, and the data load operation is completed at time t12. In such a case, it is assumed that the result of the determination in Step S105 illustrated in FIG. 5 is positive, and thus the completion response is transmitted in response to the completion of the data load operation. That is, the write data D is in the PLP ensured state.

The write data D stored in the write buffer 131 is retained in the write buffer 131 for a while and is transferred to the NAND memory 12 through a data-in operation at time t13. Then, a program operation of the write data D starts at time t14, and the program operation of the write data D is completed at time t15. The region of the write buffer 131 in which the write data D is stored is released at time t14.

At time t12, an operation responding to a write command E starts. From time t12, a data load operation for write data (represented as write data E) corresponding to the write command E is performed, and the data load operation is completed at time t13. In this case, it is assumed that the result of the determination in Step S105 is negative, thereby preventing the transmission of the completion in response to the completion of the data load operation. That is, the write data E is in the PLP non-ensured state.

The write data E stored in the write buffer 131 is retained in the write buffer 131 for a while. When a data-in operation of the write data D is completed at time t14, the write command E is determined in Step S209 illustrated in FIG. 6. It is assumed that the determination in Step S209 is positive, and the completion response to the write command E is transmitted. From time t14, the write data E is in the PLP ensured state.

The write data E is transferred to the NAND memory 12 through a data-in operation at time t16. Then, a program operation of the write data E starts at time t17, and the program operation of the write data E is completed at time t18. The region of the write buffer 131 in which the write data E is stored is released at time t17.

At time t12, an operation responding to a write command F starts in addition to the write command E. From time t12, a data load operation for write data (represented as write data F) corresponding to the write command F is performed, and the data load operation is completed at time t13. In this case, it is assumed that the result of the determination in Step S105 is negative, thereby preventing the transmission of the completion in response to the completion of the data load operation. That is, the write data F is in the PLP non-ensured state.

The write data F stored in the write buffer 131 is retained in the write buffer 131 for a while. When the data-in operation of the write data D is completed at time t14, the write command F is determined in Step S209 illustrated in FIG. 6. It is assumed that the determination in Step S209 is negative, thereby preventing the transmission of the completion response to the write command F. Even after time t14, the write data F is maintained in the PLP non-ensured state.

The write data F is transferred to the NAND memory 12 through a data-in operation at time t16. Then, at time t17, in response to the data-in operation, the completion response to the write command F is transmitted to the host 2 on the basis of the processing in Step S205. A program operation of the write data F starts at time t17, and the program operation of the write data F is completed at time t18. The region of the write buffer 131 in which the write data F is stored is released at time t17.

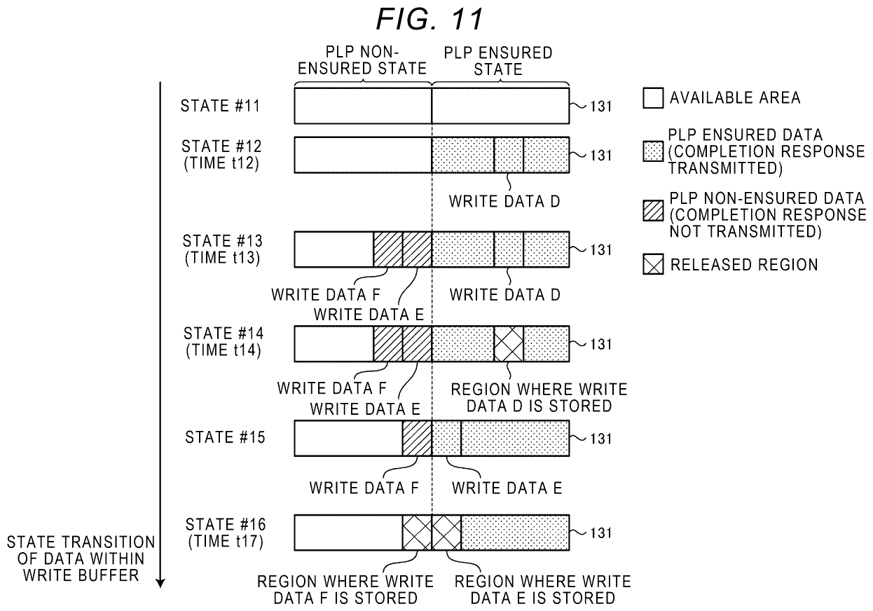

FIG. 11 is a diagram illustrating an example of the state of write data in the write buffer 131 at several timings illustrated in FIG. 10.

State #11 illustrated in FIG. 11 indicates a state in which no write data is stored in the write buffer 131.

Immediately after time t12, as shown in State #12, the amount of PLP ensured data including the write data D is equal to the ensured threshold value. Then, at time t13, as shown in State #13, the write data E and the write data F are stored in write buffer 131. Since the total amount of write data in write buffer 131 is greater than the ensured threshold value, the write data E and the write data F are in the PLP non-ensured state.

At time t14, as shown in State #14, the region in which the write data D is stored is released in response to the completion of the data-in operation of the write data D.

At time t14, the completion response to the write command E is transmitted, as shown in State #15. Thereby, the state of the write data E is changed from the PLP non-ensured state to the PLP ensured state.

At time t17, as shown in State #16, the regions in which the write data E and the write data F are stored are released in response to the completions of the data-in operations for these write data.

In such a manner, the memory system 1 may be configured such that a region of the write buffer 131 is released in response to the completion of a data-in operation.

As described above, according to the embodiment and modification examples thereof, by using a write buffer allocated in the DRAM 13, the memory controller 11 is configured to sequentially receive a plurality of pieces of write data, each of which is data requested to be written by a write command, from the host 2, and write the write data into the NAND memory 12 (refer to, for example, FIGS. 4, 8, 9, 10, and 11). The memory controller 11 manages the state of each write data in the write buffer 131 as the PLP ensured state or the PLP non-ensured state (refer to, for example, FIGS. 9 and 11). The memory controller 11 stores, into the write buffer 131, write data (represented as first write data) requested to be written by the write command (represented as a first write command) from the host 2. In such a case, if the total size of all the write data in the PLP ensured state in the write buffer 131 and the first write data is less than the ensured threshold value, the memory controller 11 transmits the completion response to the first write command in response to the storing of the first write data into the write buffer 131, and sets the state of the first write data to the PLP ensured state (for example, refer to the positive determination in S105 in FIG. 5, S106, S107, and FIGS. 8, 9, 10, and 11). If the total size of all the write data in the PLP ensured state in the write buffer 131 and the first write data is greater than the ensured threshold value, the memory controller 11 sets the state of the first write data to the PLP non-ensured state without transmitting the completion in response to the storing of the first write data into the write buffer 131 (for example, refer to the negative determination in S105 in FIG. 5, S108, and FIGS. 8, 9, 10, and 11). If the total size of all the write data in the PLP ensured state in the write buffer 131 and the first write data becomes less than the ensured threshold value by writing any write data in the PLP ensured state stored in the write buffer 131 into the NAND memory 12, the memory controller 11 transmits, to the host 2, the completion response to the first write command, and changes the state of the first write data from the PLP non-ensured state to the PLP ensured state (for example, refer to Steps S207 to S212 in FIG. 6, and FIGS. 8, 9, 10, and 11).

Accordingly, the maximum amount of write data to be saved through the PLP operation is defined by not the size of the write buffer 131 but the ensured threshold value. Therefore, the size of the write buffer 131 can be increased without an increase in capacitance of the capacitor 15 provided in the memory system 1. Alternatively, a design, in which the capacitance of the capacitor 15 provided in the memory system 1 is reduced, is possible without change in size of the write buffer 131. In other words, a design, which has a large size of the write buffer 131 relative to the amount of electrical energy that can be stored by the capacitor 15, is possible.

According to the embodiment and modification examples thereof, in response to the detection of shutdown, the memory controller 11 writes all the write data, which are stored in the write buffer 131 in the PLP ensured state, into the NAND memory 12 by using the electrical energy stored in the capacitor 15.

Therefore, it is ensured that write data corresponding to a write command for which the completion response is transmitted is written into the NAND memory 12.

As described in the embodiment, the memory controller 11 may be configured to release a region in the write buffer 131 in which write data is stored, and to end management of the state of the write data, in response to the completion of a program operation for the write data. In such a configuration, when the first write data in the PLP non-ensured state is started to be non-volatilized, the memory controller 11 transmits, to the host 2, the completion response to the first write command in response to the completion of the program operation for the first write data.

Alternatively, as described in the modification example of the embodiment, the memory controller 11 may be configured to release a region in the write buffer 131 in which write data is stored, and to end management of the state of the write data, in response to the completion of a data-in operation for the write data. In such a configuration, when the first write data in the PLP non-ensured state is started to be non-volatilized, the memory controller 11 transmits, to the host 2, the completion response to the first write command in response to completion of the data-in operation for the first write data.

In the above-described example, the ensured threshold value is set as a fixed value. The memory controller 11 may autonomously change the ensured threshold value. As described above, not only write data in the write buffer 131 but also management information is determined to be saved through the PLP operation. More specifically, management information such as, for example, the logical-to-physical address conversion table may be updated appropriately on the DRAM 13. Then, the updated part of the management information is determined to be saved. Therefore, the amount of management information to be saved through the PLP operation may change depending on the amount of updated part of the management information. The memory controller 11 may be configured to change the ensured threshold value in accordance with the amount of management information to be saved through the PLP operation.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system connectable to a host, the memory system comprising:
a first memory that is volatile;
a second memory that is nonvolatile; and
a memory controller configured to execute a first write operation, the first write operation including (i) acquiring, from the host, write data requested based on a write command from the host; (ii) storing the acquired write data in the first memory; (iii) reading the stored write data from the first memory; and (iv) writing the read write data into the second memory,
wherein the memory controller is further configured to:
manage a state of each of a plurality of pieces of write data stored in the first memory, as a first state or a second state different from the first state; and
in the first write operation for first write data requested based on a first write command from the host,
store the first write data in the first memory;
in response to the storing of the first write data in the first memory, if a first size, which is a total size of all sizes of one or more of the plurality of pieces of write data set in the first state stored in the first memory and a size of the first write data, is less than a first threshold value, transmit, to the host, a completion response to the first write command and set the state of the first write data to the first state; and
if the first size is greater than the first threshold value, set the state of the first write data to the second state without transmitting, to the host, the completion response, and
the memory controller is further configured to, as the first size becomes less than the first threshold value in response to writing, to the second memory, any one of the one or more of the plurality of pieces of write data set in the first state stored in the first memory, transmit, to the host, the completion response to the first write command, and change the state of the first write data from the second state to the first state.

2. The memory system according to claim 1, further comprising a power storage device configured to store electrical energy,
wherein the memory controller is further configured to:
in response to detecting a shutdown of power supply from outside the memory system,
write, to the second memory, all of the one or more of the plurality of pieces of write data set in the first state stored in the first memory, by using the electrical energy stored in the power storage device; and
not write, to the second memory, any one of the plurality of pieces of write data set in the second state stored in the first memory.

3. The memory system according to claim 2,
wherein the first threshold value corresponds to an amount of data that is writable into the second memory by using the electrical energy stored in the power storage device.

4. The memory system according to claim 1, wherein
the second memory includes a buffer and a memory cell array,
the first write operation includes a data-in operation for transferring the read write data to the buffer of the second memory, and a program operation for causing the second memory to write the transferred write data from the buffer into the memory cell array, and
the memory controller is further configured to:
release a region of the first memory in which the write data is stored, in response to completion of the program operation for the write data; and
end the management as to whether the write data is in the first state or the second state.

5. The memory system according to claim 4,
wherein the memory controller is further configured to transmit the completion response to the host in response to the completion of the program operation for the first write data when the memory controller starts writing the first write data in the second state to the second memory.

6. The memory system according to claim 1, wherein
the second memory includes a buffer and a memory cell array,
the first write operation includes a data-in operation for transferring the read write data to the buffer of the second memory, and a program operation for causing the second memory to write the transferred write data from the buffer into the memory cell array, and
the memory controller is further configured to:
release a region of the first memory in which the write data is stored, in response to completion of the data-in operation for the write data; and
end the management as to whether the write data is in the first state or the second state.

7. The memory system according to claim 6,
wherein the memory controller is further configured to transmit the completion response to the host in response to the completion of the data-in operation for the first write data when the memory controller starts writing the first write data in the second state to the second memory.

8. The memory system according to claim 1,
the first state is a state in which the corresponding one of the plurality of pieces of write data needs non-volatilizing due to a completion response therefor having been transmitted to the host, and
the second state is a state in which the corresponding one of the plurality of pieces of write data needs not non-volatilizing due to a completion response therefor not having been transmitted to the host.

9. The memory system according to claim 1,
wherein the memory controller is further configured to:
manage the first size by using a first list;
increase, in the first list, the first size by the size of the first write data in response to the first write data being stored in the first memory; and
decrease, in the first list, the first size by a size of the any one of the one or more of the plurality of pieces of write data set in the first state in response to the writing thereof to the second memory.

10. A memory system comprising:
a first memory that is volatile;
a second memory that is nonvolatile;
a power storage device configured to store electrical energy; and
a memory controller configured to:
manage a first data amount corresponding to a maximum amount of data that is writable into the second memory by using the electrical energy stored in the power storage device while power supply from outside the memory system is shut down;
store, in the first memory, a plurality of pieces of write data, with a data amount in total greater than the first data amount;
transmit a completion response to the host in response to storing, in the first memory, each of one or more pieces of first write data out of the plurality of pieces of write data, for each of one or more first write commands requesting writing of each of the one or more pieces of first write data; and
not transmit a completion response to the host in response to storing, in the first memory, each of one or more pieces of second write data out of the plurality of pieces of write data, for each of one or more second write commands requesting writing of each of the one or more pieces of second write data, wherein
a sum of sizes of the one or more pieces of first write data is less than or equal to the first data amount.

11. The memory system according to claim 10,
wherein the memory controller is further configured to:
as a sum of sizes of the plurality of pieces of write data stored in the first memory is changed from greater than the first data amount to less than or equal to the first data amount in response to writing, to the second memory, any one of the plurality of pieces of write data stored in the first memory, transmit the completion response to the host for one of the one or more second write commands.

12. The memory system according to claim 11,
the one of the one or more second write commands is received, from the host, the earliest timing among the one or more second write commands.

13. The memory system according to claim 10,
wherein the memory controller is further configured to:
in response to detecting the shutdown of the power supply from outside the memory system,
write, to the second memory, all of the one or more pieces of first write data stored in the first memory, by using the electrical energy stored in the power storage device; and
not write, to the second memory, any one of the one or more pieces of second write data stored in the first memory.

14. The memory system according to claim 10, wherein
the second memory includes a buffer and a memory cell array, and
the memory controller is further configured to:
transfer each of the plurality of pieces of write data from the first memory to the buffer of the second memory by a data-in operation;
cause the second memory to write the transferred write data from the buffer into the memory cell array by a program operation; and
release a region of the first memory in which the write data is stored, in response to completion of the program operation for the write data.

15. The memory system according to claim 14,
wherein the memory controller is further configured to transmit the completion response to the host for one of the one or more second write commands, in response to the completion of the program operation for the corresponding one of the one or more pieces of second write data.

16. The memory system according to claim 10, wherein
the second memory includes a buffer and a memory cell array, and
the memory controller is further configured to:
transfer each of the plurality of pieces of write data from the first memory to the buffer of the second memory by a data-in operation;
cause the second memory to write the transferred write data from the buffer into the memory cell array by a program operation; and
release a region of the first memory in which the write data is stored, in response to completion of the data-in operation for the write data.

17. The memory system according to claim 16,
wherein the memory controller is further configured to transmit the completion response to the host for one of the one or more second write commands, in response to the completion of the data-in operation for the corresponding one of the one or more pieces of second write data.

18. The memory system according to claim 10,
wherein the memory controller is further configured to:
manage a state of each of the one or more pieces of first write data as a first state; and
manage a state of each of the one or more pieces of second write data as a second state different from the first state.

19. The memory system according to claim 18,
the first state is a state in which the corresponding one of the one or more pieces of first write data needs non-volatilizing due to the completion response therefor having been transmitted to the host, and
the second state is a state in which the corresponding one of the one or more pieces of second write data needs not non-volatilizing due to the completion response therefor not having been transmitted to the host.

20. The memory system according to claim 10,
wherein the memory controller is configured to:
manage the sum of sizes of the one or more pieces of first write data by using a first list;
increase, in the first list, the sum by a size of one of the one or more pieces of first write data in response to the storing thereof in the first memory; and
decrease, in the first list, the sum by a size of one of the one or more pieces of first write data in response to the storing thereof into the second memory.
